(19) United States
(12) Patent Application Publication
(10) Pub. No.: US 2015/0271189 A1
(43) Pub. Date: Sep. 24, 2015

(54) APPARATUS AND METHOD FOR PREVENTING A VIRUS FILE FROM ILLEGALLY MANIPULATING A DEVICE

(71) Applicant: TENCENT TECHNOLOGY (SHENZHEN) COMPANY LIMITED, Shenzhen (CN)

(72) Inventor: Zixiao Nie, Shenzhen (CN)

(21) Appl. No.: 14/688,092

(22) Filed: Apr. 16, 2015

Related U.S. Application Data
(63) Continuation of application No. PCT/CN2013/084863, filed on Oct. 9, 2013.

(30) Foreign Application Priority Data
Oct. 17, 2012 (CN) 201210393867.9

(51) Int. Cl. H04L 29/06; G06F 21/56

(52) U.S. Cl. CPC H04L 63/145; H04L 63/1408; G06F 21/56

(57) ABSTRACT

A scanning module scans files in a device and generates a signal when a virus file is detected. A clearing module clears the virus file based on the signal. A monitoring module judges whether an operation on a file in the device is to be banned and generates a monitor result. An operation controlling module controls the device to ban an operation on a file in the device in response to a determination that the monitor result indicates the operation is to be banned.

### RELATED DOCUMENTS

The present invention is a continuation application of PCT/CN2013/084863 which claims priority of Chinese patent application No. 201210393867.9 titled “Apparatus and method for preventing a virus file from illegally manipulating a device” and filed on Oct. 17, 2012 with the Patent Office of the People's Republic of China, the disclosure of which is incorporated by reference in its entireties.

### TECHNICAL FIELD

The present disclosure relates to security software, and particularly, to an apparatus and a method for preventing a virus file from illegally manipulating a device.

### BACKGROUND

Confrontation between security software and viruses has lasted for a long time, and the techniques used by security software for clearing virus files from devices are also becoming more and more perfect. Conventional security software clears a virus file in a device generally by deleting a trojan virus file detected. If a process of the virus file has been running when the virus file is deleted, the process may still do harm to the user device even if the virus file has been deleted. Another method is to delete the trojan virus file after the machine restarted. But the trojan may be started before the security software is started, thus there may be already a process of the trojan running in the device when the security software deletes the trojan virus file. Furthermore, some virus may inject itself into a system process, and security software generally has few measures to fight against this type of virus because killing a system process put the security software at risks of destroying the system.

### SUMMARY

An apparatus for preventing a virus file from illegally manipulating a device may include: a scanning module, configured to scan files in a device and generate a signal when a virus file is detected; a clearing module, configured to clear the virus file according to the signal; a monitoring module, configured to judge whether an operation on a file in the device is to be banned and generate a monitoring result; an operation controlling module, configured to control the device to ban the operation on the file in the device in response to a determination that the monitoring result indicates the operation is to be banned.

A method for preventing a virus file from illegally manipulating a device may include: scanning files in the device, generating a signal when a virus file is detected; clearing the virus file according to the signal; judging whether an operation on a file in the device is to be banned and generating a monitoring result; controlling the device to ban the operation on the file in the device in response to a determination that the monitoring result indicates the operation is to be banned.

A method for preventing a virus file from illegally manipulating a device, comprising:

providing information specifying at least one file in a device and at least one operation that is not allowed to be performed on each of the at least one file;

monitoring operations on the at least one file specified in the information, judging whether an operation on a file which is one of the at least one file is to be banned and generating a monitoring result by using the information;

controlling the device to ban the operation on the file in the device in response to a determination that the monitoring result indicates the operation is to be banned.

According to examples, monitoring operations on files in the device is for dynamically obtaining information of operations to be performed on the files, e.g., writing, deleting, modifying and the like, and then judging whether the operations should be banned. Banning an operation on a file in the device is for actively protecting the file against the virus. As such, all malicious actions of virus files can be intercepted, thus the mechanism can prevent an active virus file from making destructions.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example of a computing device;

FIG. 2 is a flowchart illustrating a method for preventing a virus file from illegally manipulating a device according to an example of the present disclosure;

FIG. 3 is a block diagram illustrating an apparatus for preventing a virus file from illegally manipulating a device according to an example of the present disclosure;

FIG. 4 is a block diagram illustrating the operation controlling module in FIG. 3 according to an example of the present disclosure;

FIGS. 5, 6, 7 are flowcharts illustrating a method for preventing a virus file from illegally manipulating a device according to an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Due to characteristics of the Chinese language, quantities of an element, unless specifically mentioned, may be one or a plurality of, or at least one.

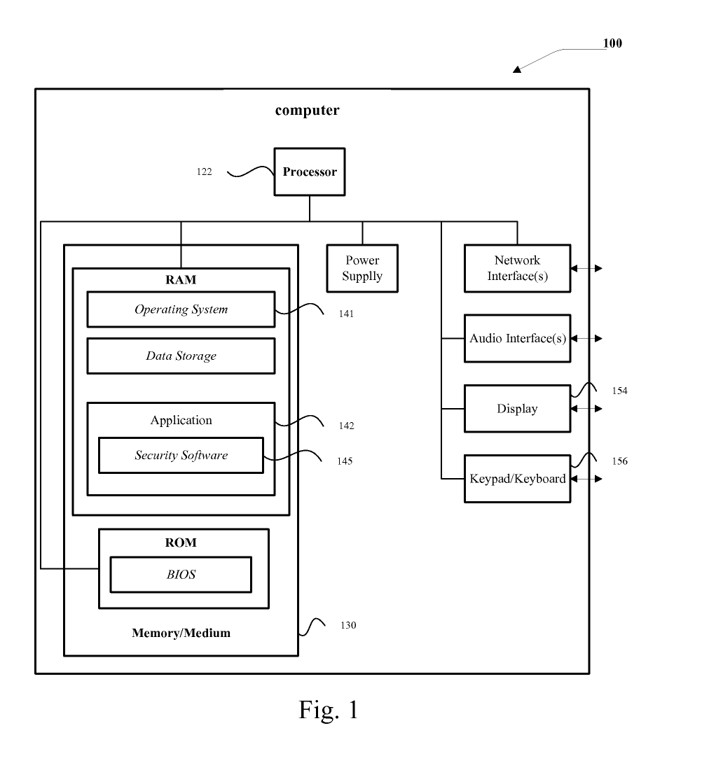

In an example, a computing device may execute methods and software systems of the present application. FIG. 1 is a schematic diagram illustrating an example of a computing device. As shown in FIG. 1, computing device 100 may be capable of executing a method and apparatus of present disclosure. The computing device 100 may, for example, be a device such as a personal desktop computer or a portable device, such as a laptop computer, a tablet computer, a cellular telephone, or a smart phone. In this situation, the computing device 100 may reside within the same device with the device protected from being illegally manipulated, and may share certain components, such as a processor and a storage medium and the like, with the protected device. The computing device 100 may also be a server that connects to the above devices locally or via a network, e.g., when the device protected from being illegally manipulated is embodied by the above devices.

The computing device 100 may vary in terms of capabilities or features. Claimed subject matter is intended to cover a wide range of potential variations. For example, the computing device 100 may include a keypad/keyboard 156. It may also comprise a display 154, such as a liquid crystal display (LCD), or a display with a high degree of functionality, such as a touch-sensitive color 2D or 3D display. In contrast, however, as another example, a web-enabled computing device 100 may include one or more physical or virtual keyboards, and mass storage medium 130.

The computing device 100 may also include or may execute a variety of operating systems 141, including an operating system, such as a Windows™ or Linux™, or a mobile operating system, such as iOS™, Android™, or Windows Mobile™. The computing device 100 may include or may execute a variety of possible applications 142, such as security software 145. An application 142 may enable preventing a virus file from manipulating the computing device 100 illegally.

Further, the computing device 100 may include one or more non-transitory processor-readable storage media 130 and one or more processors 122 in communication with the non-transitory processor-readable storage media 130. For example, the non-transitory processor-readable storage media 130 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 may store sets of instructions, or units and/or modules that comprise the sets of instructions, for conducting operations described in the present application. The one or more processors may be configured to execute the sets of instructions and perform the operations in examples of the present application.

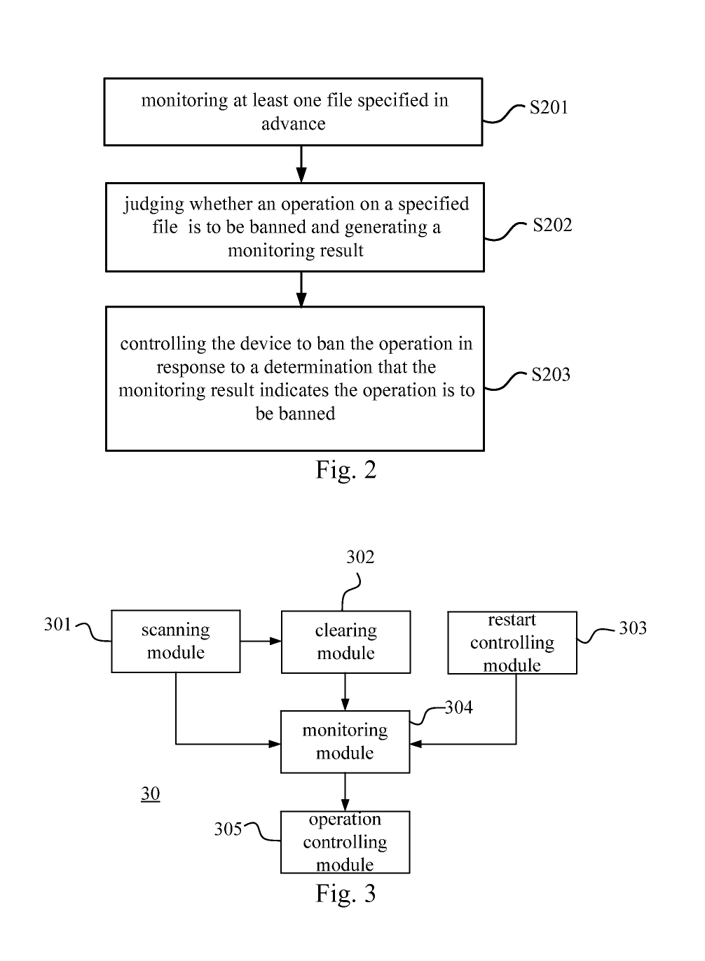

FIG. 2 is a flowchart illustrating a method for preventing a virus file from illegally manipulating a device according to an example of the present disclosure. As shown in FIG. 2, the method may include the following procedures.

Before the process is carried out, information specifying at least one file in a device and at least one operation that is not allowed to be performed on each of the at least one file may be provided.

In block S201, operations on the at least one file specified in the information are monitored.

In block S202, it is judged whether an operation on a file which is one of the at least one file to be banned, and a monitoring result is generated by using the information.

In block S203, the device is controlled to ban the operation in response to a determination that the monitoring result indicates the operation is to be banned.

In an example, the information may specify files that are often used and modified by viruses, such as the registry and the like. In another example, after a virus is detected, information of a file used or modified by the virus may also be added into the information to implement targeted monitoring and protection. The operation(s) specified in the information which is not allowed to be performed on the specified file(s) may be any or any combination of editing, writing, modifying, deleting and so on. The information may be stored in a storage device, e.g., a memory in the device, or may be obtained via a network.

In various examples, the monitoring process may be started when the device is powered on, or may be started in some specific occasions, e.g., when a process of scanning files in the device is started, when a virus is cleared, when the device restarts, and so on.

The following are some examples of the mechanism provided by the present disclosure. The examples take protecting files in a user device as an example. In the following examples, the file(s) monitored may be the file(s) specified in the information, or may be all of files in the user device.

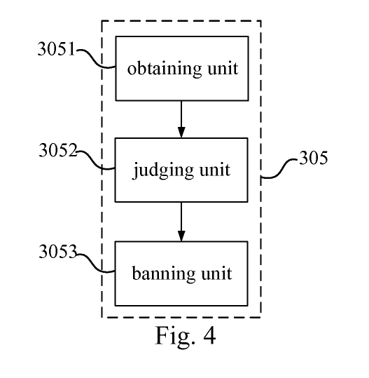

Referring to FIG. 3 and FIG. 4, FIG. 3 is a block diagram illustrating an apparatus 30 for preventing a virus file from illegally manipulating a device, and FIG. 4 is a block diagram illustrating an operation controlling module 305 in FIG. 3. In some examples, the apparatus 30 may be embodied by a security software or an anti-virus application stored in a computer-readable storage medium and capable of making a processor to implement the functions of the apparatus 30.

The apparatus 30 may include a scanning module 301, a clearing module 302, a monitoring module 304 and an operation controlling module 305. The scanning module 301 is electrically connected to the clearing module 302 and the monitoring module 304. The monitoring module 304 is electrically connected to the clearing module 302 and the operation controlling module 305. The scanning module 301 is configured to scan files in a user device, and generate a signal when a virus file is detected. The clearing module 302 is configured to clear the virus file according to the signal. The monitoring module 304 is configured to monitor operations on a file in the user device, judge whether an operation on the file in the user device is to be banned, and generate a monitoring result.

Monitoring operations on files in the user device is for dynamically obtaining information of files that are manipulated, e.g., writing, deleting, modifying and the like, and then judging whether the operations should be banned. The operation controlling module 305 is configured to control the user device to ban an operation on a file in the user device in response to a determination that the monitoring result indicates the operation is to be banned.

Banning an operation on a file in the user device is for actively protect the file from viruses. Since there are many ways for a file in the user device to get infected with virus, if illegal operations are banned passively after the virus has taken actions, best chances for protecting the file would have been missed. Therefore, banning an operation on a file in a user device is necessary during scanning the user device or during the process of clearing a virus file from the user device or during a restarting process of the user device. This is substantially a mechanism for intercepting malicious actions of virus files to actively fight against virus files.

In an example, the operation controlling module 305 may include an obtaining unit 3051, a judging unit 3052 and a banning unit 3053. The obtaining unit 3051 is electrically connected with the judging unit 3052 and the monitoring module 304. The judging unit 3052 is electrically connected with the banning unit 3053. The obtaining unit 3051 is configured to obtain an operation to be performed on a file in a user device. The operation on the file in the user device may include a writing operation, a deleting operation, a modifying operation, and so on. The judging unit 3052 is configured to judge whether the operation is to be banned and generate a judging result. The banning unit 3053 is configured to control the user device to ban an operation in response to a determination that the judging result indicates the operation is to be banned. For example, positions at high risks of being manipulated in a registry may be prohibited from being written or modified. As such, an active virus file becomes inactive because it can no longer modify the registry to look for a start opportunity. Banning operations on files can prevent an active virus file from making destructions. Thus, in the fight against viruses, the mechanism of the present disclosure is at advantages because the mechanism actively prevents all visits to registry and other files by virus files and makes active virus files become inactive.

When scanning the user device, the monitoring module 304 may be configured to monitor whether the scanning module 301 has begun scanning files in the user device and generate a first monitoring result. The obtaining unit 3051 is further configured to obtain a first operation on a file in the user device in response to a determination that the first monitoring result indicates the scanning module 301 has begun scanning files in the user device. The judging unit 3052 is further configured to judge whether the first operation is to be banned and generate a first judging result. The banning unit 3053 is configured to control the user device to ban the first operation in response to a determination that the first judging result indicates the first operation is to be banned.

When clearing the virus file from the user terminal, the monitoring module 304 in an example may also monitor whether the clearing module 302 has cleared the virus file and generate a second monitoring result so as to prevent the virus file from illegally manipulating the user device. The obtaining unit 3052 may also obtain a second operation on the file in the user device in response to a determination that the second monitoring result indicates the clearing module 302 has cleared the virus file. The judging unit 3052 may also judge whether the second operation is to be banned and generate a second judging result. The banning unit 3053 may also control the user device to ban the second operation in response to a determination that the second judging result indicates the second operation is to be banned.

During a restarting process of the user device, the apparatus 30 in an example may also include a restart controlling module 303 to actively prevent the virus file from illegally manipulating the user device. The restart controlling module 303 is electrically connected to the monitoring module 304. The restart controlling module 303 is configured to control the user device to restart. The monitoring module 104 may also monitor whether the user device is in a restarting process and generate a third monitoring result. The obtaining unit 3051 may also obtain a third operation on the file in the user device in response to a determination that the third monitoring result indicates the user device is in a restarting process. The judging unit 3052 may also judge whether the third operation is to be banned and generate a third judging result. The banning unit 3053 may also control the user device to ban the third operation in response to a determination that the third judging result indicates the third operation is to be banned.

After the user device has restarted, the monitoring module 304 in an example may also monitor whether the user device has completed the restarting process and generate a fourth monitoring result so as to actively prevent the virus file from illegally manipulating the user device. The clearing module 302 may also clear the virus file from the user device again in response to a determination that the fourth monitoring result indicates the user device has completed the restart process. The obtaining unit 3051 may also stop obtaining operations on the file in the user device in response to a determination that the fourth monitoring result indicates the user device has completed the restarting process.

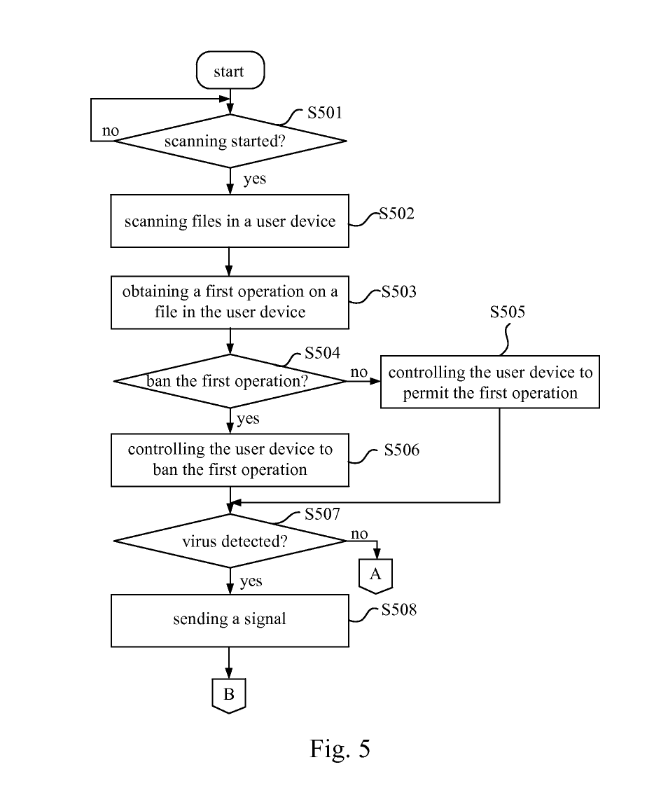

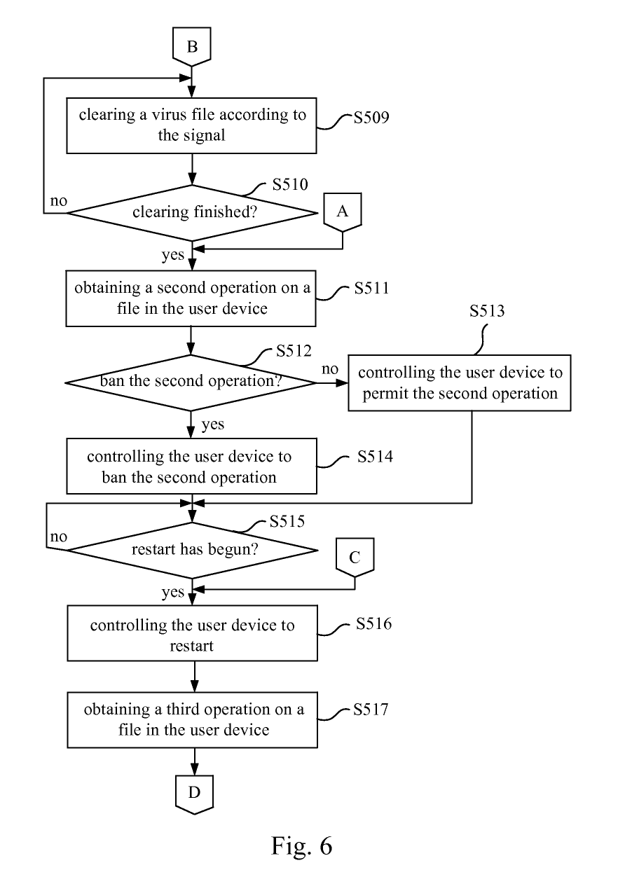

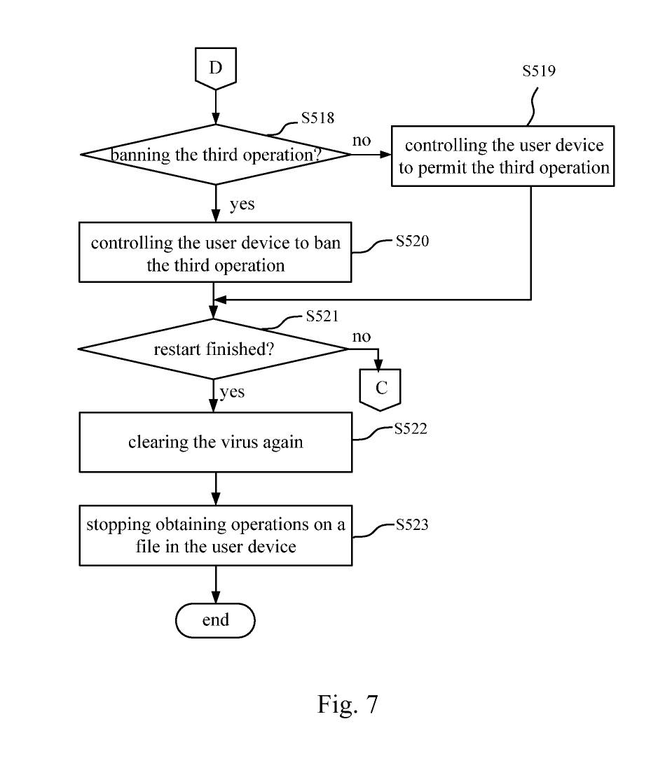

FIGS. 5, 6, 7 are flowcharts illustrating a method for preventing a virus file from illegally manipulating a user device according to an example of the present disclosure. The method is implemented by the apparatus 30 for preventing a virus file from illegally manipulating a user device.

In block S501, the monitoring module 304 monitors whether the scanning module 301 has begun to scan files in the device, the procedure in block S502 is performed in response to a determination that the scanning module 301 has begun to scan files in the user device, or keeps on monitoring in response to a determination that the scanning module 301 has not begun to scan files in the user device.

In block S502, the scanning module 301 scans files in the user device.

In block 503, the obtaining unit 3051 obtains a first operation on a file in the user device.

In block S504, the judging unit 3052 judges whether the first operation is to be banned, the procedure in block S506 is performed in response to a determination that the first operation is to be banned, or the procedure in block S505 is performed in response to a determination that the first operation is not to be banned.

In block S505, the banning unit 3053 controls the user device to permit the first operation.

In block S506, the banning unit 3053 controls the user device to ban the first operation.

In block S507, the scanning module 301 judges whether a virus file is found during the process of scanning the files in the user device, and the procedure in block S508 is performed in response to a determination that a virus file is found, or the procedure in block S511 is performed in response to a determination that no virus file is found.

In block S508, the scanning module 301 generates a signal.

In block S509, the clearing module 302 clears the virus file according to the signal.

In block S510, the monitoring module 304 monitors whether the virus file has been cleared by the clearing module 302, and the procedure in block S511 is performed in response to a determination that the virus file has been cleared by the clearing module 302, or the procedure in block S509 is performed in response to a determination that the virus file has not been cleared by the clearing module 302.

In block S511, the obtaining unit 3051 obtains a second operation on a file in the user device.

In block S512, the judging unit 3052 judges whether the second operation is to be banned, the procedure in block S514 is perform in response to a determination that the second operation is to be banned, or the procedure in block S513 is perform in response to a determination that the second operation is not to be banned.

In block S513, the banning unit 3053 controls the user device to permit the second operation.

In block S514, the banning unit 3053 controls the user device to ban the second operation.

In block S515, the monitoring module 304 monitors whether the user device is in a restarting process, and the procedure in block S516 is performed in response to a determination that the user device is in a restarting process, or keeps on monitoring in response to a determination that the user device is not in a restarting process.

In block S516, the restart controlling module 303 controls the user terminal to restart.

In block S517, the obtaining unit 3051 obtains a third operation on a file in the user device.

In block S518, the judging unit 3052 judges whether the third operation is to be banned, the procedure in block S520 is performed in response to a determination that the third operation is to be banned, or the procedure in block S519 is performed in response to a determination that the third operation is not to be banned.

In block S519, the banning unit 3053 controls the user device to permit the third operation.

In block S520, the banning unit 3053 controls the user device to ban the third operation.

In block S521, the monitoring module 304 monitors whether the user device has finished the restarting process, and the procedure in block S522 is performed in response to a determination that the user device has finished the restarting process, or keeps on monitoring in response to a determination that the user device has not finished the restarting process.

In block S522, the clearing module 302 clears the virus file again.

In block S523, the obtaining unit 3051 stops obtaining operations on the file in the user device.

In the above process, monitoring operations on files in the user device is for dynamically obtaining information of the files that are manipulated, e.g., writing, deleting, modifying and the like, and then judging whether the operations should be banned. Banning an operation on a file in the user device is for actively protect the file from the virus file. Since there are many ways for a file in the user device to get infected with virus, if illegal operations are banned passively after the virus file has performed actions, best chances for protecting the file would have been missed. Therefore, banning an operation on a file in a user device is necessary during scanning the user device or during the process of clearing a virus file from the user device or during a restart process of the user device. This is substantially a mechanism for intercepting malicious actions of virus files to effectively fight against virus files.

In various examples, the first operation, the second operation, the third operation may be writing, deleting, modifying and so on.

Banning operations on files can prevent an active virus file from making destructions. For example, positions at high risks of being manipulated in a registry may be prohibited from being written or modified. As such, an active virus file is made inactive because it can no longer modify the registry to look for a start opportunity. The mechanism actively prevents all visits to registry and other specified files by virus files and makes active virus files become inactive.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute a method as described herein. Specifically, a system or apparatus having a storage medium which stores machine-readable program codes for implementing functions of any of the above examples and which may make the system or the apparatus (or CPU or MPU) read and execute the program codes stored in the storage medium. In addition, instructions of the program codes may cause an operating system running in a computing device to implement part or all of the operations. In addition, the program codes implemented from a storage medium are written in a storage device in an extension board inserted in the computing device or in a storage in an extension unit connected to the computing device. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. An computing device for preventing a virus file from illegally manipulating a device, comprising:
a scanning module, configured to scan files in a device, and generate a signal when a virus file is detected;
a clearing module, configured to clear the virus file according to the signal;
a monitoring module, configured to monitor operations on a file in the device, judge whether an operation is to be banned, and generate a monitor result; and
an operation controlling module, configured to control the device to ban the operation on the file in the device in response to a determination that the monitoring result indicates the operation is to be banned.

2. The computing device of claim 1, wherein the operation controlling module comprises:
an obtaining unit, configured to obtain the operation on the file in the device;
a judging unit, configured to judge whether the operation is to be banned and generate a judging result; and
a banning unit, configured to control the device to ban the operation in response to a determination that the judging result indicates the operation is to be banned.

3. The computing device of claim 2, wherein the monitoring module is further configured to monitor whether the scanning module has begun to scan the files in the device and generate a first monitoring result;
the obtaining unit is further configured to obtain a first operation on a file in the device in response to a determination that the first monitoring result indicates the scanning module has begun scanning the files in the device;
the judging unit is further configured to judge whether the first operation is to be banned and generate a first judging result;
the banning unit is further configured to control the device to ban the first operation in response to a determination that the first judging result indicates the first operation is to be banned.

4. The computing device of claim 2, wherein the monitoring module is further configured to monitor whether the clearing module has finished clearing the virus file in the device and generate a second monitoring result;
the obtaining unit is further configured to obtain a second operation on the file in the device in response to a determination that the second monitoring result indicates the clearing module has cleared the virus file;
the judging unit is further configured to judge whether the second operation is to be banned and generate a second judging result;
the banning unit is further configured to control the device to ban the second operation in response to a determination that the second judging result indicates the second operation is to be banned.

5. The computing device of claim 2, wherein the memory further comprises:
a restart controlling module, configured to control the device to restart;
wherein the monitoring module is further configured to monitor whether the device is in a restarting process and generate a third monitoring result;
the obtaining unit is further configured to obtain a third operation on the file in the device in response to a determination that the third monitoring result indicates the device is in a restarting process;
the judging unit is further configured to judge whether the third operation is to be banned and generate a third judging result;
the banning unit is further configured to control the device to ban the third operation in response to a determination that the third judging result indicates the third operation is to be banned.

6. The computing device of claim 5, wherein the monitoring module is further configured to monitor whether the device has finished the restarting process and generate a fourth monitoring result;
the clearing module is further configured to clear the virus file from the device again in response to a determination that the fourth monitoring result indicates the device has finished the restart process;
the obtaining unit is further configured to stop obtaining operations on the file in the device in response to a determination that the fourth monitoring result indicates the device has finished the restarting process.

7. A method for preventing a virus file from illegally manipulating a user device, comprising:
scanning files in a user device, and generating a signal when a virus file is detected;
clearing the virus file according to the signal;
monitoring operations on a file in the user device, judging whether an operation on the file is to be banned, and generating a monitoring result;
controlling the user device to ban the operation on the file in the user device in response to a determination that the monitoring result indicates the operation is to be banned.

8. The method of claim 7, further comprising:
obtaining an operation on the file in the user device;
judging whether the operation is to be banned and generating a judging result; and
controlling the user device to ban the operation in response to a determination that the judging result indicates the operation is to be banned.

9. The method of claim 8, further comprising:
monitoring whether a scanning module has begun scanning the files in the user device and generating a first monitoring result;
obtaining a first operation on the file in the user device in response to a determination that the first monitoring result indicates the scanning module has begun scanning the files in the user device;
judging whether the first operation is to be banned and generating a first judging result; and
controlling the user device to ban the first operation in response to a determination that the judging result indicates the first operation is to be banned.

10. The method of claim 8, further comprising:
monitoring whether a clearing module has cleared the virus file and generating a second monitoring result;
obtaining a second operation on the file in the user device in response to a determination that the second monitoring result indicates the clearing module has cleared the virus file;
judging whether the second operation is to be banned and generating a second judging result; and
controlling the user device to ban the second operation in response to a determination that the judging result indicates the second operation is to be banned.

11. The method of claim 8, further comprising:
controlling the user device to restart;
monitoring whether the user device is in a restarting process and generating a third monitoring result;
obtaining a third operation on the file in the user device in response to a determination that the third monitoring result indicates the user device is in a restarting process;
judging whether the third operation is to be banned and generating a third judging result; and
controlling the user device to ban the third operation in response to a determination that the judging result indicates the third operation is to be banned.

12. The method of claim 11, further comprising:
monitoring whether the user device has finished the restarting process and generating a fourth monitoring result;
clearing the virus file from the user device again in response to a determination that the fourth monitoring result indicates the user device has finished the restart process;
stopping obtaining operations on the file in the user device in response to a determination that the fourth monitoring result indicates the user device has finished the restarting process.

13. A method for preventing a virus file from illegally manipulating a device, comprising:
providing information specifying at least one file in a device and at least one operation that is not allowed to be performed on each of the at least one file;
monitoring operations on the at least one file specified in the information, judging whether an operation on a file which is one of the at least one file is to be banned and generating a monitoring result by using the information;
controlling the device to ban the operation on the file in the device in response to a determination that the monitoring result indicates the operation is to be banned.

14. The method of claim 13, further comprising:
monitoring whether a process of scanning files in the device has begun and generating a first monitoring result;
obtaining a first operation on one of the at least one file in response to a determination that the first monitoring result indicates the process of scanning the files has begun;
judging whether the first operation is to be banned and generating a first judging result by using the information; and
controlling the device to ban the first operation in response to a determination that the judging result indicates the first operation is to be banned.

15. The method of any of claim 13, further comprising:
adding information of a file in which a virus is detected into the information specifying a file and at least one operation that is not allowed to be performed on the file.

16. The method of claim 15, further comprising:
monitoring whether the virus has been cleared and generating a second monitoring result;
obtaining a second operation on one of the at least one file specified in the information in response to a determination that the virus has been cleared;
judging whether the second operation is to be banned and generating a second judging result by using the information; and
controlling the device to ban the second operation in response to a determination that the judging result indicates the second operation is to be banned.

17. The method of claim 16, further comprising:
controlling the device to restart;
monitoring whether the device is in a restarting process and generating a third monitoring result;
obtaining a third operation on one of the at least one file specified in the information in response to a determination that the third monitoring result indicates the device is in a restarting process;
judging whether the third operation is to be banned and generating a third judging result; and
controlling the device to ban the third operation in response to a determination that the judging result indicates the third operation is to be banned.

18. The method of claim 17, further comprising:
monitoring whether the device has finished the restarting process and generating a fourth monitoring result;
clearing the virus from the device again in response to a determination that the fourth monitoring result indicates the device has finished the restart process;
stopping obtaining operations on the at least one file specified in the information in response to a determination that the fourth monitoring result indicates the device has finished the restarting process.
